(19) United States
(12) Patent Application Publication
(10) Pub. No.: US 2024/0152576 A1
(43) Pub. Date: May 9, 2024

(54) SYNTHETIC CLASSIFICATION DATASETS BY OPTIMAL TRANSPORT INTERPOLATION

(71) Applicant: Microsoft Technology Licensing, LLC, Redmond, WA (US)

(72) Inventors: David ALVAREZ-MELIS, Somerville, MA (US); Jiaojiao Fan, Atlanta, GA (US); Nicolo Fusi, Watertown, MA (US)

(21) Appl. No.: 18/077,730

(22) Filed: Dec. 8, 2022

Related U.S. Application Data
(60) Provisional application No. 63/417,868, filed on Oct. 20, 2022.

(51) Int. Cl. G06K 9/62; G06N 3/08

(52) U.S. Cl. CPC G06K 9/6256; G06K 9/6232; G06K 9/6288; G06N 3/08

(57) ABSTRACT

Generally discussed herein are devices, systems, and methods for generating synthetic datasets. A method includes obtaining a first training labelled dataset, obtaining a second training labelled dataset, determining an optimal transport (OT) map from a target labelled dataset to the first training labelled dataset, determining an OT map from the target labelled dataset to the second training labelled dataset, identifying, in a generalized geodesic hull formed by the first and second training labelled datasets in a distribution space and based on the OT maps, a point proximate the target dataset in the distribution space, and producing the synthetic labelled ML dataset by combining, based on distances between probability distribution representations of the first and second labelled training datasets in the distribution space and the point, the first and second labelled training datasets resulting in a labelled synthetic dataset.

### RELATED APPLICATION

This application claims the benefit of priority to U.S. Provisional Patent application 63/417,868 filed on Oct. 20, 2022 and titled “Generating Synthetic Datasets By Interpolating Along Generalized Geodesics”, which is incorporated herein by reference in its entirety.

### BACKGROUND

Recent progress in machine learning (ML) has been characterized by the rapid adoption of large pretrained models as a fundamental building block. These models are typically pretrained on large amounts of general purpose pretraining data, and then adapted (e.g., fine-tuned) to a specific task of interest. Such pretraining datasets usually draw from multiple heterogeneous data sources (e.g., arising from different domains or sources). Traditionally, all available datasets are used in their entirety during pretraining, for example by pooling the datasets together into a single dataset (when they all share the same label sets) or by training using all of the datasets sequentially one by one. These strategies, however, come with important disadvantages.

Training on the union of multiple datasets might be prohibitive or too time consuming, and it might even be detrimental. Indeed, there is a growing line of research showing evidence that removing pretraining data sometimes helps transfer performance. On the other hand, sequential learning (e.g., consuming datasets one by one) is prone to catastrophic forgetting, as the information from earlier datasets gradually vanishes as the model is trained on new datasets. The foregoing suggests that training on only some subset of the pretraining datasets is advantageous, how to choose the subset is unclear. However, when the target dataset on which the model is to be used is known in advance, the answer is much easier: intuitively, one would train only of those relevant to the target dataset (e.g., those datasets most similar to the target dataset). Indeed, recent work has shown that selecting pretraining datasets based on the distance to the target is a successful strategy.

### SUMMARY

This summary section is provided to introduce aspects of embodiments in a simplified form, with further explanation of the embodiments following in the detailed description. This summary section is not intended to identify essential or required features of the claimed subject matter, and the combination and order of elements listed in this summary section are not intended to provide limitation to the elements of the claimed subject matter.

Embodiments can generate a synthetic dataset that is useful for training, fine-tuning, or testing a machine learning (ML) classifier. Embodiments can determine respective optimal transport (OT) maps from a labelled dataset to multiple training labelled datasets. The OT maps can be used to form a geodesic hull. A point in the geodesic hull is selected to represent the target dataset. Distances from the point to the training labelled datasets are then used to combine the first and second training labelled datasets. The combined first and second training labelled datasets form the synthetic dataset.

Generating the synthetic dataset can include obtaining a first training labelled dataset. Generating the synthetic dataset can include obtaining a second training labelled dataset. Obtaining the dataset can include retrieving the dataset, accessing the dataset, downloading the dataset from the cloud, receiving the dataset from a client, or the like. Generating the synthetic dataset can include determining an optimal transport (OT) map from a target labelled dataset to the first training labelled dataset. Generating the synthetic dataset can include determining an OT map from the target labelled dataset to the second training labelled dataset. Generating the synthetic dataset can include identifying, in a generalized geodesic hull formed by the first and second training labelled datasets in a distribution space and based on the OT maps, a point proximate the target labelled dataset in the distribution space. Generating the synthetic dataset can include producing the synthetic labelled ML dataset by combining, based on distances between probability distribution representations of the first and second training labelled datasets in the distribution space and the point, the first and second training labelled datasets.

The target labelled dataset can include more, fewer, or different labels than labels of one or more of the first and second training labelled datasets. Combining the first and second training labelled datasets can include representing labels of the first and second training labelled datasets as respective one-hot vectors of all labels in the first and second training labelled datasets. Generating the synthetic dataset can include further training, using the synthetic labelled ML dataset, a pre-trained ML model that has been trained based on the target labelled dataset.

Determining the OT map can include performing a barycentric projection of the target labelled dataset onto the geodesic hull. The barycentric projection can include projection of sample data and separate label data. Determining the OT map can include operating an OT neural map that includes three classifiers, a label classifier, a discriminator, and a feature classifier. A discriminator loss of the discriminator can be independent of the labels.

Identifying the point proximate the target labelled dataset in the dataset space can include determining the point in the generalized geodesic hull that is closest to the target labelled dataset. Identifying the point proximate the target labelled dataset can include operating a quadratic problem solver based on a (2, ν) transport metric. Generating the synthetic dataset can include before obtaining the first or second labelled training datasets, receiving, from an application, a request for the synthetic labelled ML dataset. Generating the synthetic dataset can include responsive to producing the synthetic labelled ML dataset, providing the synthetic labelled ML dataset to the application.

### BRIEF DESCRIPTION OF DRAWINGS

FIG. 1 illustrates, by way of example, a diagram of an embodiment of a method for synthetic dataset generation using a generalized geodesic.

FIG. 2 illustrates, by way of example, a graphical diagram of an embodiment of generating a dataset based on training datasets.

FIG. 3 illustrates, by way of example, a diagram of generalizability of datasets for some common labelled datasets.

FIG. 4 illustrates, by way of example, a diagram of an embodiment of a system for synthetic dataset generation.

FIG. 5 illustrates, by way of example, a diagram of an embodiment of another system for synthetic dataset generation.

FIG. 6 illustrates, by way of example, a diagram of another embodiment of a system for synthetic dataset generation.

FIG. 7 illustrates, by way of example, a diagram of an embodiment of images organized by column into corresponding labels.

FIG. 8 illustrates, by way of example, a diagram of an embodiment of a method for synthetic dataset generation.

FIG. 9 is a block diagram of an example of an environment including a system for neural network training

FIG. 10 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

While recent work has shown that selecting pretraining datasets based on the distance to the target is a successful strategy, such methods are limited to selecting (only) among individual datasets already present in the collection.

Embodiments leverage a notion of distance between datasets based on optimal transport (OT), called the optimal transport distance (OTD) or optimal transport dataset distance (OTDD), which provides a space of joint distributions with a meaningful metric from which a distance can be derived. In general, embodiments can use OT interpolation along a geodesic between datasets to generate a new synthetic dataset in between the datasets in dataset space. While there are other methods to generate an unlabeled dataset (e.g., simple image interpolation), there are virtually no methods that handle labelled data property and accurately. For some specific settings (like robotics), there exist methods to synthesize data (like physics engines that generate simulations). For more typical machine learning (ML) settings like image classification, there are very limited options for synthetic labelled data generation.

A major challenge in synthesizing labelled data is to define what it means to interpolate between discrete class labels. Embodiments extend this previous work to provide a principled, computationally feasible, and demonstrably functional method to generate synthetic data. Compared to that work, embodiments have the following advantages:
1. Embodiments can combine samples from more than two datasets.
2. Embodiments are more computationally stable than the prior work.
3. Embodiments allow generating additional datapoints on-demand at virtually no computational cost. The prior methods require solving an entire optimization problem again and was not amenable to generating new additional datapoints after the initial method was run.
4. Embodiments have a functional solution for the issue of how to combine discrete labels (the prior techniques used a heuristic).

When given access to the target dataset of interest, one can identify, among all combinations of pre-training datasets, the synthetic dataset closest (in terms of a metric between datasets) to the target. By characterizing datasets as sampled from a underlying probability distribution, a metric between datasets can be understood as a generalization (from Euclidean to probability space) as a problem of finding among the convex hull of a set of reference points, that are closest to a query point. While this problem has a simple closed-form solution in Euclidean space (via an orthogonal projection), solving it in probability space is much more challenging. Embodiments address this problem from the perspective of interpolation.

Formally, the combination of datasets are modeled as an interpolation between their data distributions, formalized through the notion of geodesics in probability space endowed with the Wasserstein metric. Embodiments can rely on a generalized geodesic, a constant-speed curve connecting a pair (or more) of distributions parametrized with respect to a ‘base’ distribution, namely, the target dataset. Computing such geodesics requires access to either an OT coupling or map between the base distribution and every other reference distribution. The former can be computed very efficiently with off-the-shelf OT solvers, but are limited to generate only as many samples as the problem is originally solved on. In contrast, OT maps allow for on-demand out-of-sample mapping, and can be estimated using neural OT methods. However, most existing OT methods assume unlabeled (feature-only) distributions. A goal of embodiments, however, is to interpolate between classification (i.e., labeled) datasets. Therefore, a generalization of OT to labeled datasets to compute couplings can be used. Neural OT methods can be adapted and generalized to the labeled setting to estimate OT maps.

In summary, embodiments provide: (i) a novel approach to generate new synthetic classification datasets from existing ones by using geodesic interpolations, applicable even if they have disjoint label sets, (ii) two efficient methods to compute generalize geodesics, which might be of independent interest, (iii) empirical validation of the method in a transfer learning setting.

The details of a geodesic between datasets and OT are discussed further below. Reference will now be made to the FIGS. to provide further details and applications of embodiments.

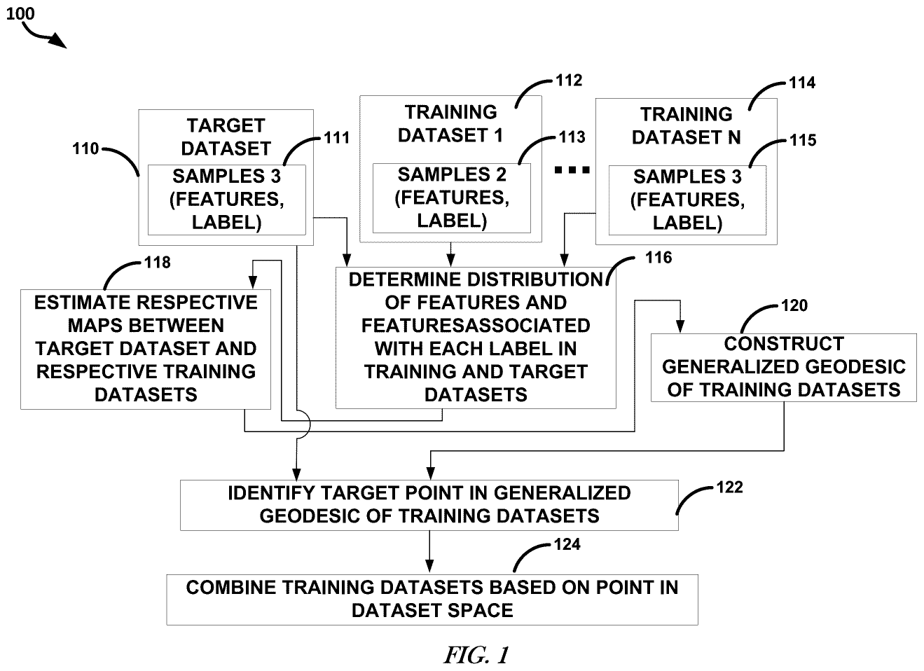

FIG. 1 illustrates, by way of example, a diagram of an embodiment of a method 100 for synthetic dataset generation using a generalized geodesic. The method 100 as illustrated includes three datasets, a training dataset 110 (which is optional if the data distribution and label distributions are known) and multiple training datasets 112, 114. While two training datasets are illustrated, any number of training datasets greater than one can be used with embodiments. The target dataset 110 is the reference dataset towards which the training datasets 112, 114 will be altered. The target dataset 110 either does not exist or has an insufficient number of samples. “Insufficient” in this context means that a model trained on the dataset has classification accuracy below a desired classification accuracy for one or more classes.

Each of the training dataset 110 and the target datasets 112, 114 includes a collection of (features, label) pairs 111, 113, 115, respectively. This means that the target dataset 110 and the training datasets 112, 114 are classification datasets. A classification dataset is a dataset that is used for training or testing an ML classifier model. Supervised ML model training typically occurs using a supervised learning technique. Each of the target dataset 110 and the training datasets 112, 114 can include a same or different number of classes (sometimes called “labels”). That is, the target dataset 110 and the training datasets 112, 114 can include classes that are different, a different number of classes, and even different categories of classes. Categories of classes include objects (e.g., type of fauna, type of alphabetic character, type of symbol, type of flora, type of food, or the like), phonemes, types (e.g., spam or not), specific person (e.g., using facial recognition), among others. Famous training datasets include a Modified National Institute of Standards and Technology (MNIST) database of hand-written Arabic numerals in which the classes are “zero”, “one”, . . . “9”; fashion-MNIST database of clothing articles in which classes are “T-shirt/top”, “Trouser”, “Pullover”, “Dress”, “Coat”, “Sandal”, “Shirt”, “Sneaker”, “Bag”, and “Ankle boot”; Chinese MNIST database of hand-written Chinese digits in which the classes are 15 Chinese digits; sign language MNIST database in which classes are 24 English alphabet characters “A”, “B”, . . . “I”, “K”, “L” . . . “Y” (all standard English alphabet characters without “J” and “Z”); among others. There are many other training datasets 112, 114 including private datasets. The training datasets 112, 114 include sufficient samples for training and testing of a given model.

At operation 116, first statistical distributions of each feature of the (features, label) pairs 111, 113, and 115 (sometimes called samples) can be determined. The statistical distribution can be represented by a distribution type (e.g., Gaussian, uniform, or the like) and corresponding parameters of the distribution type (e.g., mean, standard deviation, variance, or the like). At operation 116, a statistical distribution of each label of the (features, label) pairs 111, 113, 115 can be determined. For overlapping labels (labels in more than one dataset) the label is determined per dataset so that each label in each dataset has a distinct distribution. The distribution for each label is determined by the features of the samples that are mapped to the given label. Thus, each label is represented as [distribution of feature 1 mapped to label, distribution of feature 2 mapped to label, . . . distribution of feature f mapped to label], where f is a positive integer. A certain ML model may only look at two features, so f is a positive integer greater than one.

At operation 118, respective maps from the target dataset 110 to each of the training datasets 112, 114 are estimated. The operation 118 is performed based on the distributions determined at operation 116. There are multiple ways to perform the operation 118, which are discussed in more detail below. Some ways to perform operation 118 includes using a modified OTDD neural map and OTDD barycentric projection.

At operation 120, a generalized geodesic of the training datasets 112, 114 is constructed. A generalized geodesic is a constant-speed curve connecting a pair (or more) distributions parametrized with respect to a ‘base’ distribution (the target dataset 110). This parameterization is realized by estimating the map from the target dataset 110 to the training datasets 112, 114 rather than estimating the maps from the training datasets 112, 114 to the target dataset 110 at operation 118. More details regarding generalized geodesics are provided below. The generalized geodesics connecting the training datasets 112, 114 forms a finite dataset space. The training datasets 112, 114 can be combined to form a dataset at any point in the dataset space.

At operation 122, the a target point in the generalized geodesic of training dataset is identified. The operation 122 can include projecting the distribution of the target dataset 110 onto the dataset space formed by the generalized geodesic constructed at operation 120. The projection onto the dataset space can be estimated as the point in the dataset space closest to the target dataset 110. This point can be estimated using a quadratic programming solver. More details regarding how to identify this point are provided below.

In some cases, the target dataset 110 is not needed. In such cases, the operation 122 can include choosing a point in the dataset space formed by the generalized geodesic constructed at operation 120. A dataset at a point that is equidistant from each of the training datasets 112, 114 can help optimally fill the dataset space so that a future target dataset is more likely to be closer to a dataset in the dataset space. However, a dataset can be generated at any point in the constructed dataset space. Intuitively, a training dataset closer to the target dataset in dataset space will help improve performance of a model trained based on the target dataset and the training dataset.

At operation 124, samples of the training datasets 114 are combined to generate a dataset at the point identified at operation 122. The training datasets 114 can be combined by determining relative distance between the point and each of the training datasets. The samples of the training datasets 112, 114 can be combined using based on the distance to the point, thus weighting the contribution of samples from the datasets closer to the point more than samples from the datasets further from the point. More details regarding the operation 124 are provided below.

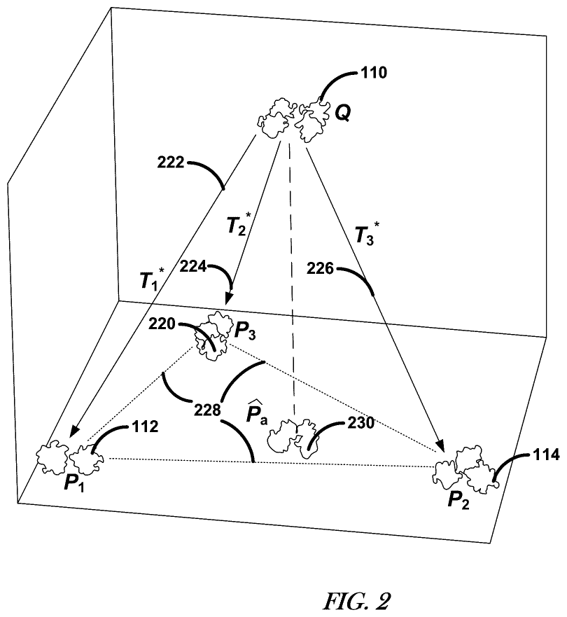

FIG. 2 illustrates, by way of example, a graphical diagram of an embodiment of generating a dataset based on training datasets. In FIG. 2, [symbol] is a target dataset 110 and Pₓ where x is a positive integer represent respective training datasets 112, 114, 220. Respective maps 222, 224, 226 (T₁*, T₂*, T₃*, respectively) between the target dataset 110 and the training datasets 112, 114, 220 are estimated (e.g., operation 118 of the method of FIG. 1). T₁* represents the map from the target dataset 110 to the training dataset 112, T₂* represents the map from the target dataset 110 to the training dataset 114, and T₃* represents the map from the target dataset 110 to the training dataset 220. Generalized geodesics 228 between datasets are determined and define a dataset space (the space within the generalized geodesics 228). Any dataset within the dataset space can be determined as a convex combination of samples from the training datasets 112, 114, 220. A point in the dataset space that is closest to the target dataset 110 can be identified. The convex combination of the training datasets 112, 114, 220 at the point can be determined to generate a synthetic dataset 230 (\hat{P}ₐ). The synthetic dataset 230 is the dataset in the dataset space that is most like the target dataset 110 and thus most likely dataset to improve training and testing of a model that is to operate based on the target dataset 110.

The target dataset 110 in some embodiments is optional. For example, if the point corresponding to the dataset 230 is a desired dataset (e.g., it is a central point (e.g., a centroid) of the datasets 220, 112, 114. The target dataset 110 can then be synthesized based on the distances between distributions that represent the datasets 220, 112, 114 in distribution space. The weighted contribution of each of the datasets 220, 112, 114 can be inversely proportional to their distances to the points in the distribution space. Generating such a synthetic dataset helps reduce a distance to a potential target dataset that lies outside of the geodesic hull formed by the geodesics 228. A dataset that is central to the datasets 220, 112, 114 can have the best generalizability for all the datasets 220, 112, 114.

To provide more details regarding operations of embodiments, it is beneficial to first provide some baseline explanation and notation. First, distributional interpolation with optimal transport (OT) and a baseline distance metric are explained to provide some baseline for more detailed explanation of the operations of embodiments. The more detailed explanation of some operations is then provided and followed by some experimental results.

Regarding interpolation between distributional representations of samples with OT, consider [symbol] ( [symbol] ) the space of probability distributions with finite second moments over some Euclidean space [symbol] . Given μ, ν ∈ [symbol] ( [symbol] ), the Monge formulation of the optimal transport problem seeks a map [symbol] : [symbol] → [symbol] that transforms μ into ν at minimal cost. Formally, the objective of this problem is [symbol] _{#μ=ν} [symbol] ∥x− [symbol] (x)∥₂²dν(x), where the minimization is over all the maps that pushforward distribution μ into distribution ν. While a solution to this problem might not exist, a relaxation due to Kantorovich is guaranteed to have a solution. This modified version yields the 2-Wasserstein distance: [symbol] ₂²(μ, ν)=min_{π∈Π(μ,ν)} [symbol] ∥x−x′∥₂²dπ(x, x′), where the constraint set Π(μ, ν)={π ∈ [symbol] ( [symbol] ²)| [symbol] _{0#}π=μ, [symbol] _{1#}π=ν} contains all couplings with marginals μand ν. The optimal such coupling is known as the OT plan. A celebrated result states that whenever [symbol] has density with respect to a Lebesgue measure, the optimal T* exists and is unique. In that case, the Kantorovich and Monge formulations coincide and their solutions are linked by π*=(Id,T*)_{#μ} where Id is the identity map. The Wasserstein-2 distance enjoys many desirable geometrical properties compared to other distances for distributions. One such property is the characterization of geodesics in probability space. When [symbol] ( [symbol] ) is equipped with metric [symbol] ₚ, the unique minimal geodesic between any two distributions μ₀ and μ₁ is fully determined by π, the OT plan between them, through the relation:

ρₜ^{D}:=((1−t)x+ty)#π(x, y), t ∈[0,1]

known as displacement interpolation. If the Monge map exists, the geodesic can also be written as

ρₜ^{M}:=((1−t)Id+tT*)#μ₁, t ∈ [0,1] (1)

and is known as McCann's interpolation. ρ₀^{M}=μ₁ and ρ₁^{M}=μ₂. Such interpolations are only defined between two distributions. When there are m≥2 marginal distributions {μ₁, . . . μₘ}, the Wasserstein barycenter ρₐ^{B}:=arg min_{ρ}Σᵢ₌₁^{m}aᵢ [symbol] ₂²(ρ, μᵢ), a ∈ Δₘ ⊂ [symbol] ^{m} generalizes McCann's interpolation. Intuitively, the interpolation parameters a=[a₁, . . . , aₘ] determine the ‘mixture proportions’ of each dataset in the combination, akin to a convex combination of points in Euclidean space. In particular, when a is a one-hot vector with aᵢ=1, then ρₐ^{B}=μᵢ i.e., the barycenter is simply the i-th distribution. Barycenters have attracted great attention in machine learning recently, but they remain challenging to compute in high dimension.

Another limitation of these interpolation notions is the non-convexity of [symbol] ₂² along them. In Euclidean space, given three points x₁, x₂, y ∈ [symbol] ^{d}, the function t [symbol] ∥xₜ−y∥₂², where xₜ is the interpolation xₜ=(1−t)x₁+tx₂, which is convex. In contrast, in Wasserstein space, neither the function t [symbol] [symbol] ₂²(ρₜ^{M}, ν) nor t [symbol] [symbol] ₂²(ρₐ^{B}, ν) are guaranteed to be convex. This lack of guarantee complicates theoretical analysis, such as in gradient flows. To circumvent this issue others have introduced the generalized geodesic of {μ₁, . . . , μₘ} with base ν and defined as ρₐ^{G}:=(Σᵢ₌₁^{m}aᵢT*ᵢ)#ν, a ∈ Δₘ, where T*ᵢ is the optimal map from ν to μᵢ.

Lemma 1. The functional μ [symbol] [symbol] ₂²(μ, ν) is convex along the generalized geodesics, and [symbol] ₂²(ρₐ^{G}, ν)≤Σᵢ₌₁^{m}aᵢ [symbol] ₂²(μᵢ, ν).

Thus, unlike the barycenter, the generalized geodesic does yield a notion of convexity satisfied by the Wasserstein distance and is also easier to compute. For these reasons, the generalized geodesic can be used for interpolation in embodiments. The generalized geodesic, in the form discussed thus far, is not capable of being applied on a labelled dataset.

A dataset distance, of which operation 116 is a part, is now provided. Consider a dataset

$${𝒟}_{P} = {\{ {z}^{( i )} \}}_{i = 1}^{N} = {\{ {x}^{( i )} , {y}^{( i )} \}}_{i = 1}^{N} {∼}^{i . i . d .} P ( x , y ) .$$

The Optimal Transport Dataset Distance (OTDD) measures its distance to another dataset D_{Q} as:

$${d}_{OT}^{2} ( {D}_{P} , {D}_{Q} ) = {min}_{π ∈ \prod ( P , Q )} \int ( {‖ x - {x}^{′} ‖}_{2}^{2} + {𝒲}_{2}^{2} ( {α}_{y} , {α}_{{y}^{′}} ) ) d π ( z , {z}^{′} ) \qquad ( 2 )$$

which defines a proper metric between datasets. Here, α_{y}, α_{y′} are class-conditional measures corresponding to P(x|y) and Q(x|y′). This distance is strongly correlated with transfer learning performance, i.e., the accuracy achieved when training a model on [symbol] _{P} and then fine-tuning and evaluating on [symbol] _{Q}. Therefore, it can be used to select pretraining datasets for a given target domain.

The notation P is now used to represent both a dataset and its underlying distribution for simplicity. To avoid confusion, ν and μ represent distributions in the feature space, which is Euclidean space, and use P and [symbol] to represent distributions in the product space of features and labels.

Embodiments include at least two operations (i) estimating optimal transport maps between the target dataset and all training datasets (e.g., operation 118), and (ii) using the maps to generate a convex combinations of these datasets by interpolating along generalized geodesics (e.g., operation 120). For some applications, projection to the target dataset into the ‘convex hull’ of the training datasets can be performed (e.g., at operation 122).

There are multiple ways to perform the operation 118. One is using neural OT and another uses entropy-regularized OT (a “barycentric projection”). The OTDD is a special case of Wasserstein distance, so it is natural to consider the alternative Monge (map-based) formulation to (2).

Barycentric projections can be efficiently computed for entropic regularized OT using the Sinkhorn algorithm. Assume independent identically distributed (i.i.d.) samples X_{ν}=(x_{ν}⁽¹⁾, . . . , x_{ν}^{(N}^{_{ν}}⁾), X_{μ}=(x_{μ}⁽¹⁾, . . . , x_{μ}^{(N}^{_{μ}}⁾) from two distributions ν and μ separately. After solving the optimal coupling π*:=min_{π∈Π(ν,μ)}∫(∥x−x′∥₂²dπ(x, x′), the barycentric projection can be expressed as T_{B}(X_{ν})=N_{ν}π*X_{μ}. Embodiments extend the method to two datasets Z_{Q}={X_{Q}, Y_{Q}}, Z_{P}={X_{P}, Y_{P}}, where there is additional label data Y_{Q}={y_{Q}⁽¹⁾, . . . , y_{Q}^{(N}^{_{Q}}⁾}, Y_{P}={y_{P}⁽¹⁾, . . . , y_{P}^{(N}^{_{P}}⁾}. First, the optimal coupling π* for OTDD ( [symbol] ) is determined so that labels can be represented as one-hot vectors y ∈ [symbol] ^{C}. The barycentric projection can be divided into two parts as T_{B}(Z_{Q})=[N_{Q}π*X_{P}, N_{Q}π*Y_{P}] (3).

However, this approach has at least two limitations: it cannot naturally map out-of-sample data and it does not scale well to large datasets (due to the quadratic dependency on sample size).

OTDD neural map. Embodiments can include a framework for estimating the OTDD using an OTDD neural network. A prior approach to solving a Monge OT problem with general cost functions includes solving a max-min dual problem

$${sup}_{f} {inf}_{T} \int c ( x , T ( x ) ) - f ( T ( x ) ) ] dv ( x ) + \int f ( {x}^{′} ) d μ ( {x}^{′} ) .$$

Embodiments extend this to distributions including labels by introducing an additional classifier in the map. Given two datasets P, [symbol] , the map [symbol] _{N}: [symbol] ^{d}× [symbol] ^{C}^{_{Q}}→ [symbol] ^{d}× [symbol] ^{C}^{_{P}} can be parameterized as [symbol] _{N}(z)= [symbol] _{N}(x, y)=[x̅; y̅]=[G(z); lG(z))] where G(⋅): [symbol] ^{d}→ [symbol] ^{d} is the pushforward feature map, and the l(⋅): [symbol] ^{d}→ [symbol] ^{C}^{_{P}} is a frozen classifier that is pre trained on the dataset P. Notice that, with the cost c(z, [symbol] (z))=∥x−G(z)∥₂² [symbol] ₂²(α_{y}, α_{y̅}), the Monge formulation of OTDD ( [symbol] ) is inf_{T#Q=P}∫∥x−G(z)∥₂²+ [symbol] ₂²(α_{y}, α_{y̅})dQ(z). Embodiments therefore propose to solve the max-min dual problem:

$${sup}_{f} {inf}_{G} \int [ {‖ x - G ( z ) ‖}_{2}^{2} + {𝒲}_{2}^{2} ( {α}_{y} , {α}_{\overline{y}} ) ] dQ ( z ) - \int f ( \overline{x} , \overline{y} ) dQ ( z ) + \int f ( {x}^{′} , {y}^{′} ) dP ( {z}^{′} ) . \qquad ( 4 )$$

Implementation details are provided below. Compared to previous conditional Monge map solvers, the two methods proposed here: (i) do not assume class overlap across datasets, allowing for maps between datasets with different label sets; (ii) are invariant to class permutation and re-labeling; (iii) do not force one-to-one class alignments (e.g., samples can be mapped across dissimilar classes using embodiments).

Computing a dataset based on a generalized geodesic requires constructing convex combinations of data points from different datasets. Given a weight vector a ∈ [symbol] ^{m}, features can be naturally combined as xₐ=Σᵢ₌₁^{m}aᵢxᵢ. But combining labels is not as simple because: (i) embodiments allow for datasets with a different number of labels, so adding them directly is not possible; (ii) embodiments do not assume different datasets have the same label sets, e.g. MNIST (digits) vs CIFAR10 (objects). All labels cab be represented in a same dimensional space by padding them with zeros in all entries that are not labels in the given dataset. As an example, consider three datasets, with 2, 3, and 4 classes respectively. Given a first label vector y₁ ∈ [symbol] ² for a first dataset, a second label vector for a second dataset y₂ ∈ [symbol] ³, and a third label vector for a third dataset y₃ ∈ [symbol] ⁴, the label vectors can be embedded it into a combined label vector \tilde{y}ᵢ in [symbol] ⁹ as [y₁; y₂; y₃]. Then, for a given combined i^{th} label entries of other datasets are set to zero, so, for example, \tilde{y}₁=[y₁; 0,0,0; 0,0,0,0], \tilde{y}₂=[0,0; y₂; 0,0,0,0], and \tilde{y}₃=[0,0; 0,0,0; y₃]. The label for the synthetic dataset can then be computed as yₐ=a₁\tilde{y}₁+a₂\tilde{y}₂+a₃\tilde{y}₃. This representation is lossless and preserves the distinction of labels across datasets.

Projection onto generalized geodesic of datasets is now discussed. First, operation 118 is performed to compute OTDD maps T* between Q and all other datasets [symbol] ᵢ, i=1, . . . , m using the discrete or neural OT approaches. Then, for any interpolation vector a ∈ Δₘ a dataset along the generalized geodesic can be identified as [symbol] ₐ:=(Σᵢ₌₁^{m}aᵢT*ᵢ)#Q. By using the convex combination method discussed previously, embodiments can efficiently sample from [symbol] ₐ.

Locating the dataset P*ₐ that minimizes the distance between [symbol] ₐ and Q, i.e. the projection of Q onto the generalized geodesic, is now discussed. Approaching this problem from a Euclidean viewpoint, suppose there are several distributions {μᵢ}ᵢ₌₁^{m} and an additional distribution ν on Euclidean space [symbol] ^{d}, Lemma [symbol] guarantees there exists a unique parameter a* that minimizes [symbol] ₂²(ρₐ^{G}, ν). However, it is not straightforward to locate a* because there is no closed-form formula of the map a [symbol] [symbol] ₂²(ρₐ^{G}, ν) and it can be expensive to calculate [symbol] ₂²(ρₐ^{G}, ν) for all possible a. To solve this problem, another transport distance, a (2,ν)-transport metric, can be used.

Definition 1. The (2,ν)-transport metric is given by [symbol] _{2,ν}(μᵢ, μⱼ):=(∫∥T*ᵢ(x)−T*ⱼ(x)|₂²dν(x))^{1/2}, where T*ᵢ is the optimal map from ν to μᵢ.

When ν has density with respect to a Lebesgue measure, [symbol] _{2,ν} is a valid metric. The closed-form formula of the map a [symbol] [symbol] ₂²(ρₐ^{G}, ν) can be derived.

Proposition 1. [symbol] _{2,ν}²(ρₐ^{G}, ν)=Σᵢ₌₁^{m}aᵢ [symbol] _{2,ν}²(μᵢ, ν)−1/2Σ_{i≠j}aᵢaⱼ [symbol] _{2,ν}²(μᵢ, μⱼ).

This equation implies that given distributions {μᵢ}, ν in Euclidean space, one can trivially solve the optimal a* that minimizes [symbol] _{2,ν}²(ρₐ^{G}, ν) by a quadratic programming solver. A transport metric for datasets can be defined as in Definition 2.

Definition 2. The squared (2, [symbol] )-dataset distance is given by [symbol] _{2,Q}²(Pᵢ, Pⱼ):=∫||xᵢ−xⱼ||₂²+ [symbol] ₂²(a_{yi}, a_{yj}))dQ(z), where [xᵢ; yᵢ]=T*ᵢ(z) where T*ᵢ is the OTDD map from Q to Pᵢ.

Denote [symbol] _{2,Q}( [symbol] × [symbol] ( [symbol] )) as the set of all probability measures P that satisfy d_{OT}(P, Q)<∞ and the OTDD map from Q to P exists. The following result shows that (2, [symbol] )-dataset distance is a proper distance.

Proposition 2. [symbol] _{2,Q} is a valid metric on [symbol] _{2,Q}( [symbol] × [symbol] ( [symbol] )).

Unfortunately, in this case [symbol] _{2,Q}²(Pᵢ, Pⱼ) does not have an analytic form like before because Brenier's theorem may not hold for a general transport cost problem. However, still consider [symbol] _{2,Q}²(Pᵢ, Pⱼ) and define an approximated projection \hat{P}ₐ as the minimizer of function

[symbol]

²(Pₐ, Q):=Σᵢ₌₁^{m}aᵢ [symbol] _{2,Q}²(Pᵢ, Q)−1/2Σ_{i≠j}aᵢ [symbol] _{2,Q}²(Pᵢ, Pⱼ) (5)

which is an analog of Proposition 1. Unlike the Wasserstein distance, [symbol] _{2,Q}²( [symbol] )is easier to compute because it does not involve optimization, so it is relatively cheap, computationally speaking, to locate the minimizer of [symbol] ²(Pₐ, Q). Experimentally, observe that [symbol] ²(Pₐ, Q) is predictive of model transferability across tasks.

FIG. 2 illustrates a role of the optimal map in estimating the projection of a dataset into a generalized geodesic hull of three training datasets. Using maps T*ᵢ estimated via barycentric projection results in a better preservation of class structure as compared non-optimal maps Tᵢ based on random couplings (as the usual mixup does), as the random couplings destroy class structure.

Embodiments have been used to generate new pretraining datasets for few-shot learning. Given m labeled pretraining datasets {Pᵢ}, consider a few-shot test dataset, in which only partial data is labelled (e.g. 5 samples per class). Suppose the training resource and time are both limited such that the user can choose only one dataset to train the model, in the meantime, the user expects the model to have the best ability to generalize that is possible. To this end, assume the training dataset is chosen from the generalized geodesic {Pₐ}. With a choice of the one-hot weight vector a, Pₐ recovers the original dataset Pᵢ for some i. Otherwise, Pₐ will be the interpolation of datasets {Pᵢ}. Note, the generalization ability of training models has a strong correlation with the distance [symbol] _{2,Q}²(Pₐ, Q)

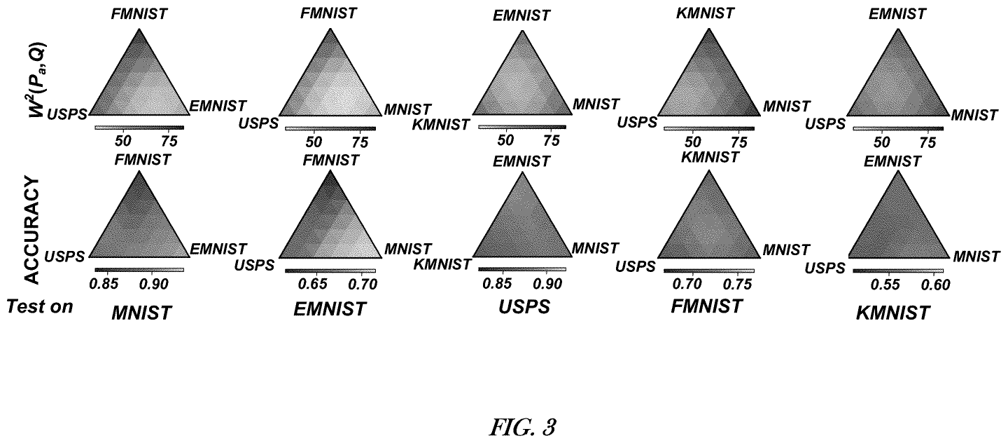

Connection to generalization. The closed-form expression of [symbol] _{2,ν}²(ρₐ^{G}, ν) (Prop. [symbol] ) provides the distance between a base distribution ν and the distribution along generalized geodesic ρₐ^{G} in Euclidean space. The analog (5) for labelled datasets [symbol] and {Pᵢ} is provided in FIG. 3.

To investigate the generalization abilities of models trained on different datasets, a simplex Δ₃ was discretized to obtain 36 interpolation parameters a. The interpolation parameters were used to train a 5-layer LeNet classifier on each Pₐ. Then all of these classifiers were fine-tuned on the few-shot test dataset [symbol] with only 20 samples per each class. The same number of training iterations and fine-tuning iterations were used across all experiments. The second row of FIG. 3 shows fine-tuning accuracy. Comparing the first row and the second row, the accuracy and W₂(Pₐ, Q) are highly correlated. This implies that the model trained on the minimizer dataset of W₂(Pₐ, Q) tends to have a better generalization ability. The same colorbar range is fixed for all heatmaps across datasets in FIG. 3 to highlight the different impact of choosing training dataset. For some test datasets, the choice of training dataset can affect the fine-tuning accuracy greatly. For example, when [symbol] is EMNIST and the training dataset is FMNIST, the fine-tuning accuracy is only ˜60%, but this can be improved to about 70% by choosing an interpolated dataset closer to MNIST. This is reasonable because MNIST shares more similarity with EMNSIT than FMNIST or USPS. To some test datasets like FMNIST and KMNIST, this difference is not so obvious because all training datasets are all far away from the test dataset.

Next, a comparison of embodiments with several baseline methods on NIST datasets is provided. In each set of experiments, one dataset is selected as the target dataset, and the rest of the “NIST” datasets are the training datasets. Assume the test dataset is 5-shot. To do this, randomly choose 5 samples per class to be the labeled data, and treat the remaining samples as unlabeled. Embodiments train a model on \hat{P}ₐ, and fine-tune the model on a 5-shot test dataset. To obtain \hat{P}ₐ, use barycentric projection or neural map to approximate the OTDD maps from test dataset to the training datasets. Results are shown in the first two rows in Table 1 below. The first baseline method is to create a synthetic dataset as training dataset by Mixup among datasets. For this a convex combination with weight â of randomly sampled data was determined for each of the training datasets. The convex combination is determined as discussed previously, thus this baseline is equivalent to embodiments with suboptimal OTDD maps. The other two baselines (the bottom block in Table 1) skip the transfer learning part, and directly train the model or solve 1-NN on the few-shot test dataset. Overall, transfer learning can bring additional knowledge from other domains and improve the test accuracy by at most 21%. Among the methods in the first block, training on datasets generated by OTDD barycentric projection outperforms others except USPS dataset, where the difference is only about 2.6%.

TABLE 1
Pretraining on synthetic data. 5-shot transfer
accuracy is shown (mean ± s.d. over 5 runs).

| Methods | MNIST | USPS | FMNIST | KMNIST | EMNIST |
|---|---|---|---|---|---|
| OTDD | 93.74 ± | 86.01 ± | 70.12 ± | 52.55 ± | 67.06 ± |
| barycentri [symbol] | 1.4 [symbol] | 1.5 [symbol] | 3.0 [symbol] | 2.7 [symbol] | 2.55 [symbol] |
| projection | | | | | |
| OTDD | 88.78 ± | 83.80 ± | 70.02 ± | 50.32 ± | 65.32 ± |
| Neural map | 3.8 [symbol] | 1.6 [symbol] | 2.5 [symbol] | 3.1 [symbol] | 1.80 [symbol] |
| Mixup am [symbol] | 88.68 ± | 88.61 ± | 66.74 ± | 48.16 ± | 60.95 ± |
| Datasets | 1.5 [symbol] | 2.0 [symbol] | 3.7 [symbol] | 3.3 [symbol] | 1.3 [symbol] |
| Train on f [symbol] | 72.80 ± | 80.73 ± | 60.50 ± | 41.67 ± | 53.60 ± |
| Shot datas [symbol] | 3.1 [symbol] | 2.0 [symbol] | 3.0 [symbol] | 2.1 [symbol] | 1.18 [symbol] |
| 1-NN on f [symbol] | 63.40 ± | 76.18 ± | 61.32 ± | 55.66 ± | 39.66 ± |
| Shot datas [symbol] | 2.9 [symbol] | 1.9 [symbol] | 2.2 [symbol] | 2.1 [symbol] | 0.50 [symbol] |

[symbol]

indicates data missing or illegible when filed

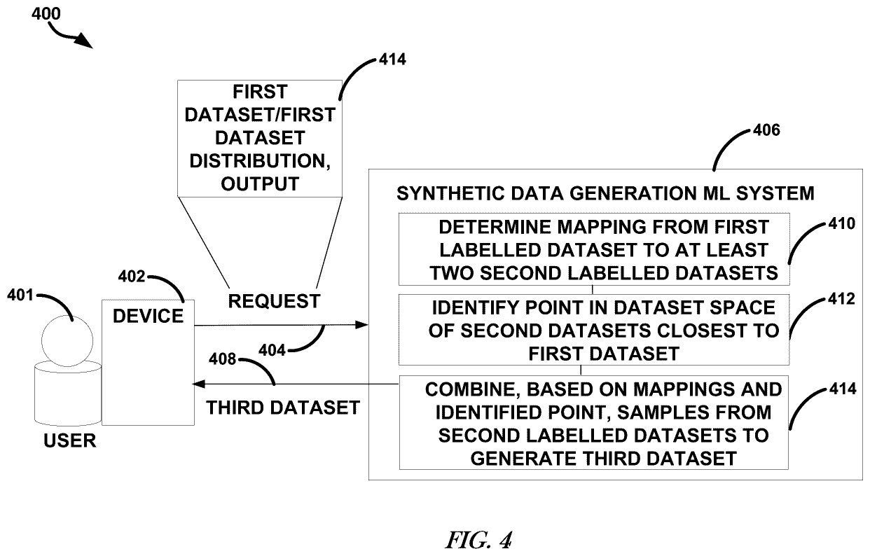

FIG. 4 illustrates, by way of example, a diagram of an embodiment of a system 400 for synthetic dataset generation. The system 400 as illustrated includes a user 401 with a device 402. The device 402 can issue a request 404 to a synthetic dataset generation ML system 406. The request 404 can indicate a location of a first dataset, include the first dataset, or the like. The request 404 can indicate a result desired, such as an ML model, data that meets certain criteria, or the like.

The device 402 is a compute device, such as a computer (e.g., laptop, desktop, handheld, smartphone, tablet, phablet, or the like). The device 402 can access the synthetic dataset generation ML system 406. The synthetic dataset generation ML system 406 can operate on the first dataset to satisfy a dataset objective. In the example of FIG. 4 the user 401 has requested more data, such as for training or classification (e.g., using a traditional ML paradigm). The synthetic dataset generation ML system 406 can include processing circuitry configured to implement operations 410, 412, 414.

The processing circuitry can include electric or electronic components, software or firmware executing on the electronic or electronic components, or a combination thereof. The electric or electronic components can include one or more resistors, transistors, capacitors, diodes, inductors, logic gates (e.g., AND, OR, XOR, negate, buffer, or the like), switches, power supplies, oscillators, analog to digital converters, digital to analog converters, amplifiers, memory devices, processing devices (e.g., a central processing unit (CPU), field programmable gate array (FPGA), graphics processing unit (GPU), application specific integrated circuit (ASIC), or the like), a combination thereof, or the like).

The request 404 as illustrated includes a first dataset or a distribution of a first dataset and a desired output (classification, dataset, ML model, or the like). The distribution of the first dataset can include a mean, covariance, shape (e.g., mixture of Gaussian, or the like).

The operation 410 includes determining respective mappings from a first labelled dataset to at least two labelled training datasets. The operation 412 can include identifying one or more points in a dataset space formed by the second labelled datasets that is closest to the first dataset. A closer dataset can provide data that more valuable for training, fine tuning, testing, or the like of an ML model configured to operate on the first dataset. The second datasets can be combined, at operation 414. The proportions of the second datasets in the combination can be based on distances to the identified point from operation 412.

The third dataset 408 generated as a result of the operation 414 can then be provided to the user 401, via the device 402, for example. The third dataset 408 can then be used as additional data of the first dataset for further training, fine-tuning, or testing of the ML model. The user 401 can then have more data to train and/or test an ML model using a traditional ML paradigm.

Additionally, or alternatively, the privacy of persons associated with the data in the first or second datasets can be preserved by operating on the third dataset 408. The third dataset 408 can be considered samples from a distribution representing the first dataset. The additional data provided by the third dataset 408 can help improve the accuracy, reduce bias, or the like of the ML model of concern to the user 401.

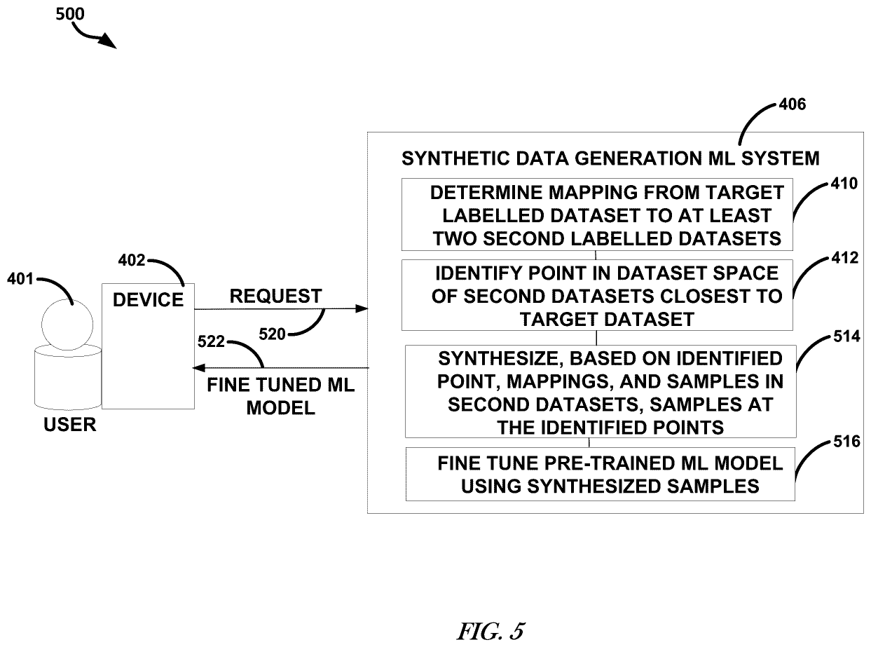

FIG. 5 illustrates, by way of example, a diagram of an embodiment of another system 500 for dataset optimization. The system 500 is similar to the system 400, with the request 520 of the system 500 being different than the request 404 of the system 400 causing the synthetic data generation ML system 406 to provide a different output (a fine-tuned model 522 in the example of FIG. 5). The the synthetic data generation ML system 406 of the system 500 receives the request 520 communicated by the device 402. The request 520, in the example of FIG. 5, is for an ML model 522. The synthetic data generation ML system 406 can perform the operation 410 as it does in the system 400.

The synthetic data generation ML system 406 can perform the operation 412 as it does in the ML system 400. At operation 514, the the synthetic data generation ML system 406 synthesizes a third dataset of synthesized samples based on the point identified at operation 412, mappings determined at operation 410, and samples from the second labelled datasets. The operation 514 can include generating a generalized geodesic hull of the second datasets. The operation 514 can include combining samples from the second labelled datasets based on distances between respective datasets and the identified point. The operation 516 includes fine tuning, or otherwise further tuning, an ML model based on the synthesized samples.

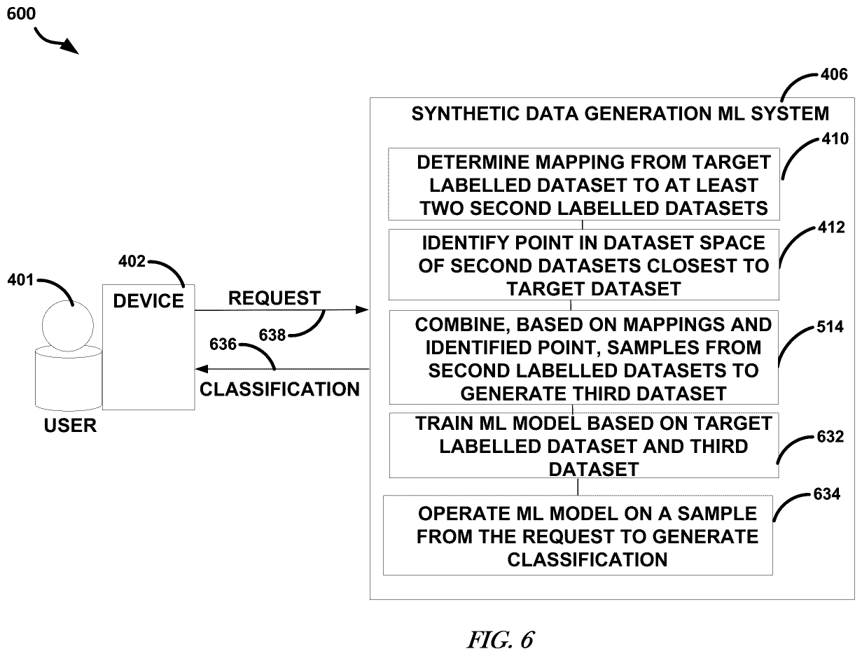

FIG. 6 illustrates, by way of example, a diagram of another embodiment of a system 600 for dataset optimization. The system 600 is similar to the systems 400 and 500 with the synthetic data generation ML system 406 of FIG. 6 performing some different operations than the systems 400, 500. In the system 600, the user 401 issues a request 638 for a classification 636. The user 401, in any of the systems 400, 500, 600, can provide (i) a distribution (e.g., mean and covariance) for features mapped to labels of a first dataset of which the data to be classified is a member, (ii) features associated with the labels, (iii) the first dataset, or a combination thereof.

The synthetic data generation ML system 406 can perform operations 410, 412 similar to the systems 400, 500. The synthetic data generation ML system 406 can perform operation 514 similar to the system 500.

The synthetic data generation ML system 106 can further train an ML model (pre-trained on the target dataset) using the third dataset, at operation 632. The synthetic data generation ML system 406 can operate the trained ML model on one or more samples provided in the request 638 to generate the classification 636.

A problem with determining distances between feature, label pairs is that features are continuous (vectors) and labels are discrete. Determining a distance between features can be performed many ways. However, the discrete nature of labels makes it more difficult to determine distances between feature, label pairs. A solution provided by embodiments is to represent the label as a distribution of features mapped to the label. Then, a differentiable distance metric can be used to determine a distance between distributions (labels).

The complexity of solving OTDD barycentric projection by Sinkhorn algorithm is O(N²), where N is the number of samples in both datasets. This can be expensive for a large-scale dataset. In practice, it is beneficial to solve the batched barycentric projection, i.e. take a batch from source and target datasets and solve the projection from source batch to target batch, and normally fix a batch size B as 10⁴. This reduces the complexity from O(N²) to O(BN). The complexity of solving OTDD neural map is O(BKH), where K is number of iterations, and H is the size of the network. K=O(N) was chosen in the experiments. The complexity of solving all the (2,Q)-dataset distances in (5) is O(m²N) since the dataset distance is to be solved between each pair of training datasets. Putting these pieces together, the complexity of approximating the interpolation parameter â for the minimizer of (5) is O(N(B+m²)).

The generation of synthetic dataset relies on solving OTDD maps from a target dataset to each training dataset. These OTDD maps are tailored to the considered target dataset and cannot be reused for a new target dataset. Another limitation is the framework is based on model training and fine-tuning pipeline. This can be resource demanding for large-scale models, like a generative pre-trained transformer (GPT) model.

OTDD barycentric projection can be performed using an existing OTDD solver available at https://github.com/microsoft/otdd (last accessed Oct. 27, 2022). Regarding OTDD neural map, to solve the problem ( [symbol] ), parameterize f,G, [symbol] to be three neural networks. In NIST dataset experiments, one can parameterize f as ResNet, and take feature map G to be UNet. One can generate the labels y̅ with a pre-trained classifier [symbol] (⋅), and use a LeNet or VGG-5 with Spinal layers to parameterize [symbol] (⋅). In 2D Gaussian mixture experiments, one can use Residual MLP to represent all of them. One can remove a discriminator's condition on a label to simplify a loss function as

$${sup}_{f} {inf}_{G} \int [ {‖ x - G ( z ) ‖}_{2}^{2} + {𝒲}_{2}^{2} ( {α}_{y} , {α}_{\overline{y}} ) ] dQ ( z ) - \int f ( \overline{x} ) dQ ( z ) + \int f ( {x}^{′} ) dP ( {z}^{′} ) \qquad ( 6 )$$

In (6), the first term in the first integral is the feature loss, the second term in the first integral is the label loss, and the second and third integrals in combination are the discriminator loss. In (6), it is assumed that both y and y̅ are hard labels, but in practice, the output of [symbol] (⋅) is a soft label. Simply taking the argmax to get a hard label can break the computational graph, so one can replace the label loss [symbol] ₂²(α_{y}, α_{y̅}) by y^{T}My̅, where M ∈ [symbol] ^{C}^{_{Q}}^{×C}^{_{P}} is the label-to-label matrix where M(i,j):= [symbol] ₂²(α_{yi}, α_{yj}), and y is the one-hot label from dataset [symbol] . The matrix M is precomputed before the training, and is frozen during the training One can pre-train the feature map G to be identity map before the main adversarial training One can use the exponential moving average of the trained feature maps as the final feature map.

For all the NIST dataset experiments the images were rescaled to size 32×32, and their channels were repeated 3 times to obtain 3-channel images. A default train-test split from torchvision can be used. For the experimental results provided, the OTDD neural map can be used and trained with learning rate 10⁻³ and batch size 64. A LeNet was trained for 2000 iterations, and fine-tuned for 100 epochs. Regarding the comparison with other baselines, for transfer learning methods, a SpinalNet was trained for 10⁴ iterations, and fine-tuned for 2000 iterations on a test dataset. Training from scratch on the test dataset can take 2000 iterations.

Embodiments are markedly different from mixup and in-domain interpolation, dataset synthesis in ML, and discrete OT, neural OT, and gradient flows. Mixup and related in-domain interpolation generating training data through convex combinations was popularized by mixup: a simple data augmentation technique that interpolates features and labels between pairs of points. Mixup improves in-domain model robustness and generalization by increasing in-distribution diversity of the training data. Although sharing some intuitive principles with mixup, embodiments interpolate entire datasets—rather than individual datapoints—with the goal of improving across-distribution diversity and therefore out-of-domain generalization as compared to in-distribution diversity.

Dataset synthesis in machine learning generates data beyond what is provided as a training dataset is a crucial component of ML in practice. Basic transformations such as rotations, cropping, and pixel transformations can be found in most state-of-the-art computer vision models. Generative Adversarial Nets (GAN) have been used to generate synthetic data in various contexts, a technique that has proven particularly successful in the medical imaging domain. Since GANs are trained to replicate the dataset on which they are trained, these approaches are typically confined to generate in-distribution diversity, and typically operate on features only.

Discrete OT, neural OT, and gradient flows barycentric projection are typical effective methods to approximate an OT map with discrete regularized OT. Other than this, neural net based optimal map in Euclidean space has made great progress recently and reveal its power in image generation, style transfer. However, the study of the optimal map between two datasets is relatively scarce. Some conditional Monge map solvers utilize the label information in a semi-supervised manner, where they assume the label-to-label correspondence between two distributions is known. Embodiments mapping is distinct from this because embodiments do not enforce the label-to-label mapping. Based on the optimal coupling or map, geodesics and interpolation in general metric spaces have been studied extensively in the OT and metric geometry literatures, albeit mostly in a theoretical setting. Gradient flows, as an alternative approach for interpolation between distributions, have become increasingly popular in ML to model existing processes or solving optimization problems over datasets, but they are computationally more expensive than embodiments.

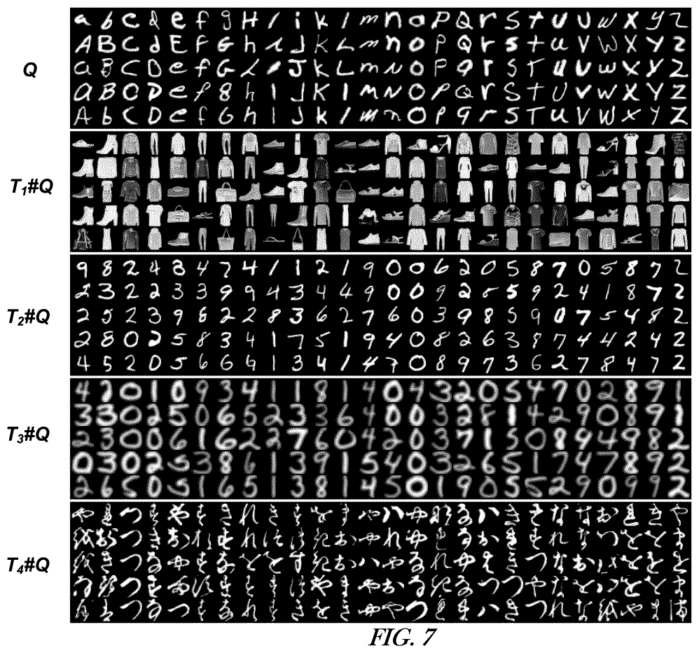

FIG. 7 illustrates, by way of example, a diagram of an embodiment of images organized by column into corresponding labels. extended MNIST (EMNIST) was selected as the target dataset for the example of FIG. 7. Each of the training datasets is mapped to have 26 labels (a number of letters in the English alphabet) regardless of the number of labels in the training dataset. At this point, three traits of OTDD map are confirmed: 1) no training label to target label correspondence is assumed. This allows for mapping between two datasets with disparate labels, such as EMNIST and FashinMNIST; 2) The mapping is invariant to the permutation of label assignment. For example, given two different original labels, the final OTDD map will be the same; 3) the mapping does not enforce the label-to-label mapping but instead follows feature similarity. From FIG. 7, notice many cross-class mapping behaviors. For example, when the training domain is the USPS dataset, the lower-case letter “l” is always mapped to digit 1, and the capital letter “L” is mapped to other digits such as 6 or 0 because the map follows the feature similarity.

Our OTDD map can be extended to generate McCann's interpolation between datasets. Embodiments can use an anolog of McCann's interpolation ( [symbol] ) in the dataset space. McCann's interpolation between datasets P₀ and P₁ can be altered and defined as

Pₜ^{M}:=((1−t)ID+t [symbol] *) P₀, t ∈ [0.1]

where [symbol] * is the optimal OTDD map from P₀ to P₁ and t is the interpolation parameter. The superscript M of Pₜ^{M} means McCann. The same convex combination method discussed previously can be used to obtain samples from Pₜ^{M}. Assume (x₀, y₀)˜P₀, (x₁, y₁)= [symbol] *(x₀, y₀) and P₀, P₁ contain 7 and 3 classes, respectively, i.e. y₀ ∈ [symbol] ⁷, y₁ ∈ [symbol] ³. Then the combination of features is xₜ=(1−t)x₀+tx₁, and the combination of labels is

$${y}_{t} = ( 1 - t ) [ \begin{matrix}{y}_{0} \\ {0}_{3}\end{matrix} ] + t [ \begin{matrix}{0}_{7} \\ {y}_{1}\end{matrix} ] .$$

Thus (xₜ, yₜ) is a sample from ((1−t)ID+t [symbol] *)#P₀. Embodiments can use a modified version of McCann's method to map the labelled data from a target dataset to a training dataset, and do the interpolation between them. Thus it can be used to map abundant data from an external dataset, to a scarce dataset for data augmentation. For example, a target dataset that only has 30 samples, and a source dataset that has 60000 samples can be used. The OTDD neural map between them can be determined and the interpolation between them can be solved to create new data out of the domain of the target distribution, which Mixup cannot achieve.

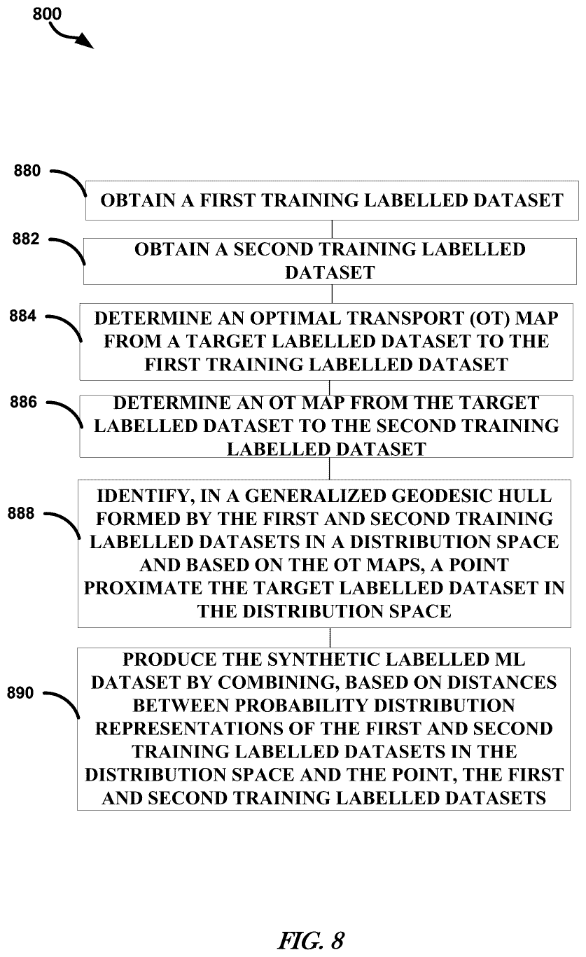

FIG. 8 illustrates, by way of example, a diagram of an embodiment of a method 800 for synthetic dataset generation. The method 800 as illustrated includes obtaining a first training labelled dataset, at operation 880; obtaining a second training labelled dataset, at operation 882; determining an optimal transport (OT) map from a target labelled dataset to the first training labelled dataset, at operation 884; determining an OT map from the target labelled dataset to the second training labelled dataset, at operation 886; identifying, in a generalized geodesic hull formed by the first and second training labelled datasets in a distribution space and based on the OT maps, a point proximate the target labelled dataset in the distribution space, at operation 888; and producing the synthetic labelled ML dataset by combining, based on distances between probability distribution representations of the first and second training labelled datasets in the distribution space and the point, the first and second training labelled datasets, at operation 890.

The method 800 can further include, wherein the target labelled dataset includes more, fewer, or different labels than labels of one or more of the first and second training labelled datasets. The method 800 can further include, wherein combining the first and second training labelled datasets includes representing labels of the first and second training labelled datasets as respective one-hot vectors of all labels in the first and second training labelled datasets. The method 800 can further include further training, using the synthetic labelled ML dataset, a pre-trained ML model that has been trained based on the target labelled dataset.

The method 800 can further include, wherein determining the OT map includes performing a barycentric projection of the target labelled dataset onto the geodesic hull. The method 800 can further include, wherein the barycentric projection includes projection of sample data and separate label data. The method 800 can further include, wherein determining the OT map includes operating an OT neural map that includes three classifiers, a label classifier, a discriminator, and a feature classifier. The method 800 can further include, wherein a discriminator loss of the discriminator is independent of the labels.

The method 800 can further include, wherein identifying the point proximate the target labelled dataset in the dataset space includes determining the point in the generalized geodesic hull that is closest to the target labelled dataset. The method 800 can further include, wherein identifying the point proximate the target labelled dataset includes operating a quadratic problem solver based on a (2, ν) transport metric. The method 800 can further include before obtaining the first or second labelled training datasets, receiving, from an application, a request for the synthetic labelled ML dataset. The method 800 can further include, responsive to producing the synthetic labelled ML dataset, providing the synthetic labelled ML dataset to the application.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object recognition, device behavior modeling (as in the present application) or the like. The operation 118, synthetic data generation ML system 406, operation 410, operation 516, operation 632, operation 634, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

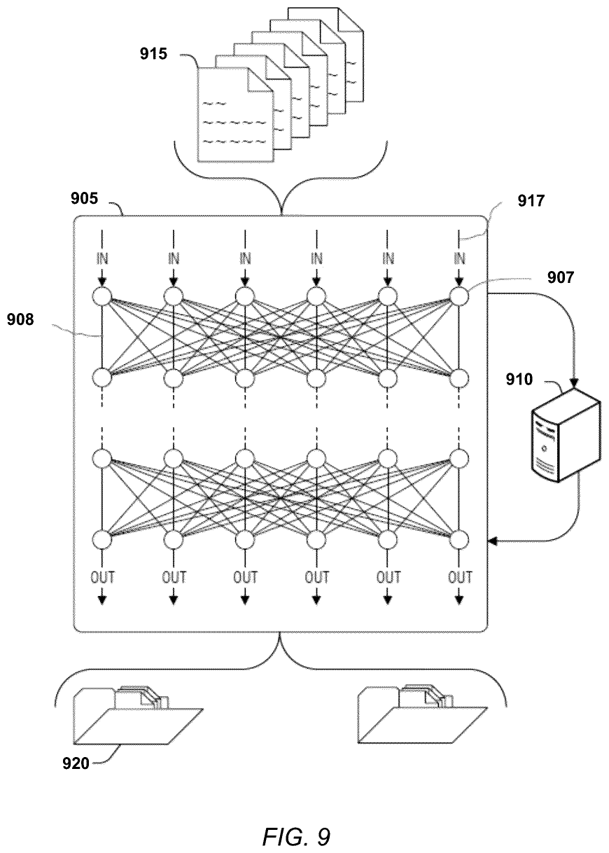

FIG. 9 is a block diagram of an example of an environment including a system for neural network training The system includes an artificial NN (ANN) 905 that is trained using a processing node 910. The processing node 910 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 905, or even different nodes 907 within layers. Thus, a set of processing nodes 910 is arranged to perform the training of the ANN 905.

The set of processing nodes 910 is arranged to receive a training set 915 for the ANN 905. The ANN 905 comprises a set of nodes 907 arranged in layers (illustrated as rows of nodes 907) and a set of inter-node weights 908 (e.g., parameters) between nodes in the set of nodes. In an example, the training set 915 is a subset of a complete training set. Here, the subset may enable processing nodes with limited storage resources to participate in training the ANN 1005.

The training data may include multiple numerical values representative of a domain, such as an image feature, or the like. Each value of the training or input 917 to be classified after ANN 905 is trained, is provided to a corresponding node 907 in the first layer or input layer of ANN 905. The values propagate through the layers and are changed by the objective function.

As noted, the set of processing nodes is arranged to train the neural network to create a trained neural network. After the ANN is trained, data input into the ANN will produce valid classifications 920 (e.g., the input data 917 will be assigned into categories), for example. The training performed by the set of processing nodes 907 is iterative. In an example, each iteration of the training the ANN 905 is performed independently between layers of the ANN 905. Thus, two distinct layers may be processed in parallel by different members of the set of processing nodes. In an example, different layers of the ANN 905 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 907 (e.g., neurons) are trained independently. In an example, the nodes are trained on different hardware.

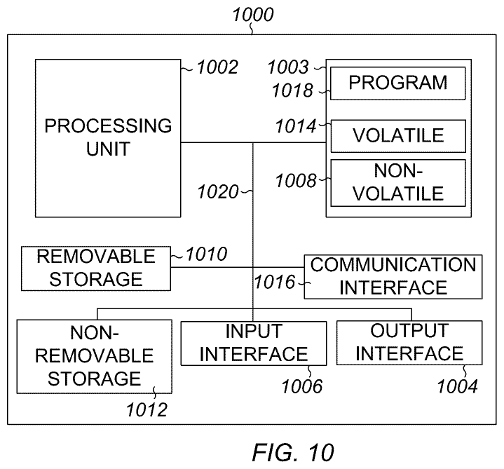

FIG. 10 illustrates, by way of example, a block diagram of an embodiment of a machine 1000 (e.g., a computer system) to implement one or more embodiments. One or more of the target dataset 110, training dataset 112, 114, or other data can be stored by the machine 900. One or more of the operations 116, 118, 120, 122, 124, 410, 412, 414, 514, 516, 632, 634, 802, 804, 806, device 402, synthetic data generation ML system 406, can be performed or implemented using the machine 1000. One example machine 1000 (in the form of a computer), may include a processing unit 1002, memory 1003, removable storage 1010, and non-removable storage 1012. Although the example computing device is illustrated and described as machine 1000, the computing device may be in different forms in different embodiments. For example, the computing device may instead be a smartphone, a tablet, smartwatch, or other computing device including the same or similar elements as illustrated and described regarding FIG. 10. Devices such as smartphones, tablets, and smartwatches are generally collectively referred to as mobile devices. Further, although the various data storage elements are illustrated as part of the machine 1000, the storage may also or alternatively include cloud-based storage accessible via a network, such as the Internet.

Memory 1003 may include volatile memory 1014 and non-volatile memory 1008. The machine 1000 may include—or have access to a computing environment that includes—a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1000 may include or have access to a computing environment that includes input 1006, output 1004, and a communication connection 1016. Output 1004 may include a display device, such as a touchscreen, that also may serve as an input device. The input 1006 may include one or more of a touchscreen, touchpad, mouse, keyboard, camera, one or more device-specific buttons, one or more sensors integrated within or coupled via wired or wireless data connections to the machine 1000, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1002 of the machine 1000. A hard drive, CD-ROM, and RAM are some examples of articles including a non-transitory computer-readable medium such as a storage device. For example, a computer program 1018 may be used to cause processing unit 1002 to perform one or more methods or algorithms described herein.

Additional notes and examples:

Example 1 includes a computer-implemented method for generating a synthetic labelled machine learning (ML) dataset, the method including obtaining a first training labelled dataset, obtaining a second training labelled dataset, determining an optimal transport (OT) map from a target labelled dataset to the first training labelled dataset, determining an OT map from the target labelled dataset to the second training labelled dataset, identifying, in a generalized geodesic hull formed by the first and second training labelled datasets in a distribution space and based on the OT maps, a point proximate the target labelled dataset in the distribution space, and producing the synthetic labelled ML dataset by combining, based on distances between probability distribution representations of the first and second training labelled datasets in the distribution space and the point, the first and second training labelled datasets.

In Example 2, Example 1 further includes, wherein the target labelled dataset includes more, fewer, or different labels than labels of one or more of the first and second training labelled datasets.

In Example 3, Example 2 further includes, wherein combining the first and second training labelled datasets includes representing labels of the first and second training labelled datasets as respective one-hot vectors of all labels in the first and second training labelled datasets.

In Example 4, at least one of Examples 1-3 further includes further training, using the synthetic labelled ML dataset, a pre-trained ML model that has been trained based on the target labelled dataset.

In Example 5, at least one of Examples 1-4 further includes, wherein determining the OT map includes performing a barycentric projection of the target labelled dataset onto the geodesic hull.

In Example 6, Example 5 further includes, wherein the barycentric projection includes projection of sample data and separate label data.

In Example 7, at least one of Examples 1-6 further includes, wherein determining the OT map includes operating an OT neural map that includes three classifiers, a label classifier, a discriminator, and a feature classifier.

In Example 8, Example 7 further includes, wherein a discriminator loss of the discriminator is independent of the labels.

In Example 9, at least one of Examples 1-7 further includes, wherein identifying the point proximate the target labelled dataset in the dataset space includes determining the point in the generalized geodesic hull that is closest to the target labelled dataset.

In Example 10, Example 9 further includes, wherein identifying the point proximate the target labelled dataset includes operating a quadratic problem solver based on a (2, ν) transport metric.

In Example 11, at least one of Examples 1-10 further includes before obtaining the first or second labelled training datasets, receiving, from an application, a request for the synthetic labelled ML dataset, and responsive to producing the synthetic labelled ML dataset, providing the synthetic labelled ML dataset to the application.

Example 12 can include a system including a memory and processing circuitry configured to implement the method of at least one of Examples 1-11.

Example 13 can include a machine-readable medium including instructions that, when executed by a machine, cause the machine to perform the method of at least one of Examples 1-11.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

As discussed in the Background, data for pretraining machine learning (ML) models often consists of collections of heterogeneous datasets. Although training on the union of such datasets is reasonable in agnostic settings, it might be suboptimal when the target domain—where the ML model will ultimately be used—is known in advance. In that case, one would ideally pretrain only on the dataset(s) most similar to the target one. Instead of limiting this choice to those datasets already present in the pretraining collection, embodiments extend available datasets to all datasets that can be synthesized as ‘combinations’ of the heterogeneous datasets in a dataset space spanned by the heterogenous datasets. Such combinations are sometimes called “multi-dataset interpolations” or “synthetic datasets”. The multi-dataset interpolations can be realized through generalized geodesics from optimal transport (OT) theory. The generalized geodesic is a curve that connects datasets and along which interpolation can be performed. The generalized geodesics can be combined to form a hull that is computed using a distance between labeled datasets. Alternative interpolation schemes can then be used to combine datasets: using either barycentric projections or optimal transport maps, among others. The optimal transport map can be computed using neural OT methods (neural networks that solve OT problems), for example. Embodiments are scalable, efficient, and can be used to interpolate even between datasets with distinct and unrelated label sets. Through various experiments in transfer learning, embodiments are shown to be useful for targeted on-demand dataset synthesis.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer-implemented method for generating a synthetic labelled machine learning (ML) dataset, the method comprising:
obtaining a first training labelled dataset;
obtaining a second training labelled dataset;
determining an optimal transport (OT) map from a target labelled dataset to the first training labelled dataset;
determining an OT map from the target labelled dataset to the second training labelled dataset;
identifying, in a generalized geodesic hull formed by the first and second training labelled datasets in a distribution space and based on the OT maps, a point proximate the target labelled dataset in the distribution space; and
producing the synthetic labelled ML dataset by combining, based on distances between probability distribution representations of the first and second training labelled datasets in the distribution space and the point, the first and second training labelled datasets.

2. The computer-implemented method of claim 1, wherein the target labelled dataset includes more, fewer, or different labels than labels of one or more of the first and second training labelled datasets.

3. The computer-implemented method of claim 2, wherein combining the first and second training labelled datasets includes representing labels of the first and second training labelled datasets as respective one-hot vectors of all labels in the first and second training labelled datasets.

4. The computer-implemented method of claim 1, further comprising further training, using the synthetic labelled ML dataset, a pre-trained ML model that has been trained based on the target labelled dataset.

5. The computer-implemented method of claim 1, wherein determining the OT map includes performing a barycentric projection of the target labelled dataset onto the geodesic hull.

6. The computer-implemented method of claim 5, wherein the barycentric projection includes projection of sample data and separate label data.

7. The computer-implemented method of claim 1, wherein determining the OT map includes operating an OT neural map that includes three classifiers, a label classifier, a discriminator, and a feature classifier.

8. The computer-implemented method of claim 7, wherein a discriminator loss of the discriminator is independent of the labels.

9. The computer-implemented method of claim 1, wherein identifying the point proximate the target labelled dataset in the dataset space includes determining the point in the generalized geodesic hull that is closest to the target labelled dataset.

10. The computer-implemented method of claim 9, wherein identifying the point proximate the target labelled dataset includes operating a quadratic problem solver based on a (2, ν) transport metric.

11. The computer-implemented method of claim 1, further comprising:
before obtaining the first or second labelled training datasets, receiving, from an application, a request for the synthetic labelled ML dataset; and
responsive to producing the synthetic labelled ML dataset, providing the synthetic labelled ML dataset to the application.

12. A non-transitory machine-readable medium including instructions that, when executed by a machine, cause the machine to perform operations for generating a synthetic labelled machine learning (ML) dataset, the operations comprising:
obtaining a first training labelled dataset;
obtaining a second training labelled dataset;
determining an optimal transport (OT) map from a target labelled dataset to the first training labelled dataset;
determining an OT map from the target labelled dataset to the second training labelled dataset;
identifying, in a generalized geodesic hull formed by the first and second training labelled datasets in a distribution space and based on the OT maps, a point proximate the target labelled dataset in the distribution space; and
producing the synthetic labelled ML dataset by combining, based on distances between probability distribution representations of the first and second training datasets in the distribution space and the point, the first and second training datasets.

13. The non-transitory machine-readable medium of claim 12, wherein the target labelled dataset includes more, fewer, or different labels than labels of one or more of the first and second training labelled datasets.

14. The non-transitory machine-readable medium of claim 13, wherein combining the first and second training labelled datasets includes representing labels of the first and second training labelled datasets as respective one-hot vectors of all labels in the first and second training labelled datasets.

15. The non-transitory machine-readable medium of claim 12, wherein the operations further comprise further training, using the synthetic labelled ML dataset, a pre-trained ML model that has been trained based on the target labelled dataset.

16. The non-transitory machine-readable medium of claim 12, wherein determining the OT map includes performing a barycentric projection of the target labelled dataset onto the geodesic hull.

17. The non-transitory machine-readable medium of claim 16, wherein the barycentric projection includes projection of sample data and separate label data.

18. A system for generating a synthetic labelled machine learning (ML) dataset, the system comprising:
processing circuitry; and
a memory coupled to the processing circuitry, the memory including instructions that, when executed by the processing circuitry, cause the processing circuitry to perform operations comprising:
obtaining a first training labelled dataset;
obtaining a second training labelled dataset;
determining an optimal transport (OT) map from a target labelled dataset to the first training labelled dataset;
determining an OT map from the target labelled dataset to the second training labelled dataset;
identifying, in a generalized geodesic hull formed by the first and second training labelled datasets in a distribution space and based on the OT maps, a point proximate the target labelled dataset in the distribution space; and
producing the synthetic labelled ML dataset by combining, based on distances between probability distribution representations of the first and second training datasets in the distribution space and the point, the first and second training datasets.

19. The system of claim 18, wherein determining the OT map includes operating an OT neural map that includes three classifiers, a label classifier, a discriminator, and a feature classifier.

20. The system of claim 19, wherein a discriminator loss of the discriminator is independent of the labels.
